(19) United States
(12) Patent Application Publication
(10) Pub. No.: US 2019/0053340 A1
(43) Pub. Date: Feb. 14, 2019

(54) SYSTEMS AND METHODS FOR LIGHTING AUTOMATION AND CONTROL

(71) Applicant: Noir Lighting, Inc., Chandler, AZ (US)

(72) Inventor: Scott Menor, Chandler, AZ (US)

(73) Assignee: Noir Lighting, Inc., Chandler, AZ (US)

(21) Appl. No.: 16/059,346

(22) Filed: Aug. 9, 2018

Related U.S. Application Data
(60) Provisional application No. 62/544,211, filed on Aug. 11, 2017.

(51) Int. Cl. H05B 33/08; F21V 23/04; H05B 37/02; G06F 15/18

(52) U.S. Cl. CPC H05B 33/089; G06F 15/18; H05B 37/0254; F21V 23/0485

(57) ABSTRACT

A semi-autonomous or autonomous system providing a means of controlling lighting, fans, and other electric loads. The system may include a user interface that presents similarly to a traditional rocker or other form of light switch. The system may sense one or more conditions using one r more types of sensors and react based on the sensed conditions. Examples of reactions may include dynamically compensating for changes in ambient temperature or light level, dimming before bedtime or brightening before waking to influence circadian rhythms, and turning on and off based on presence or absence in an environment.

### RELATED APPLICATIONS

This patent application is related to U.S. Provisional Application No. 62/544,211 filed Aug. 11, 2018, entitled “SYSTEMS AND METHODS FOR LIGHTING AUTOMATION AND CONTROL” in the name of the same inventor, and which is incorporated herein by reference in its entirety. The present patent application claims the benefit under 35 U.S.C. § 119(e).

### BACKGROUND OF THE INVENTION

Traditionally, lighting and fan automation requires significant infrastructure, such as hubs and base stations, and significant effort to setup configure and use. Such automation often includes voice commands or the ability to remotely control lights and fans from a coffee shop, but focuses little on actual usability and simplicity.

A need exists for. improved systems and methods for automating control of lights, fans, and other household systems.

### SUMMARY OF THE INVENTION

An aspect of the invention is directed to a semi-autonomous switching element that enables integration of one or more sensor data streams to identify current needs and wants and accommodate them as best as possible while requiring the minimum amount of user intervention.

Additional aspects of the present disclosure will become readily apparent to those skilled in the art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modification in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this speculation are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the presented invention will be obtained by reference to the following detailed description that sets forth illustrative embodiments, in which the principles of the invention are utilized, and the accompanying drawings of which:

FIG. 1 shows an example of an intelligent light switch in accordance with an embodiment of the invention.

FIG. 2 shows a simplified circuit diagram for a single-pole alternating current switch;

FIG. 3 shows a simplified circuit diagram for a single pole alternating current switch realized with a rectifier;

FIG. 4. shows a simplified circuit diagram for a resistive voltage divider and analog digital converter to measure line voltages;

FIG. 5. shows simplified circuit diagrams for capacitive and inductive loads;

FIG. 6 shows timing for are impulse that can be used to identify the dominant load on a circuit;

FIG. 7 shows simplified impulse response curves for capacitive and inductive loads;

FIG. 8 shows leading and trailing edge timing for dimming capacitive and inductive dominated loads;

FIG. 9 shows a soft startup sequences for a load like an LED, light, and a startup sequence for an AC fan;

FIG. 10 shows a simplified circuit diagram of a three-way switch wiring;

FIG. 11 shows a simplified circuit diagram for a single switch driving a light and a fan;

FIG. 12 shows one possible capacitive touch sensor;

FIG. 13 shows control of perceived light intensity using an ambient light sensor;

FIG. 14 shows adjusting the mix of light sources and/or shades;

FIG. 15 shows light level dimming to simulate sunset before bedtime;

FIG. 16 shows inference of activity using ambient sound analysis;

FIG. 17 shows connecting to cloud services via a smart phone;

FIG. 18 shows a memory map for multiple firmware images with a boot loader and fail safe;

FIG. 19 shows over the air firmware updates via smart phone;

FIG. 20 shows watchdog timer for failure detection and recovery; and

FIG. 21 shows onboard and cloud machine learning.

### DETAILED DESCRIPTION OF THE INVENTION

The invention provides systems and methods for autonomous and semi-autonomous lighting and fan control. Various aspects of the invention described herein may be applied to any of the particular applications set forth below or for any other types of lighting and fan control applications. The invention may be applied as a standalone device or method, or as part of an integrated home automation system. It shall be understood that different aspects of the invention can be appreciated individually, collectively, or in combination with each other.

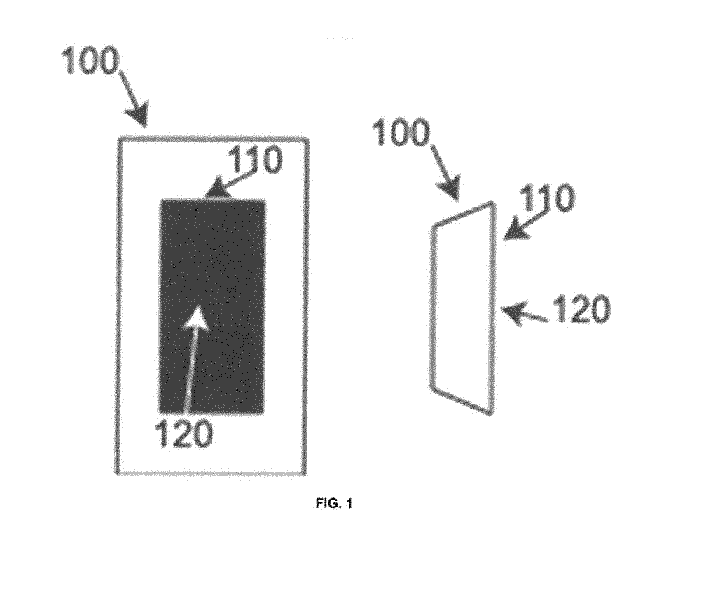

FIG. 1 shows an example of a switch 100 in accordance with an embodiment, of the invention. The switch may have a touch sensor 110 and an indicator 120. In some embodiments, the switch may also include an actuator to generate tactile feedback. In some embodiments, the switch may also include a graphical display.

The switch may include a microphone or other vibration sensor. The vibration or sound sensor can be used to passively identify activity by analyzing the ambient sound in an environment. In some embodiments, the switch may also include a camera or ambient light sensor.

In this disclosure the invention is presented integrated into a switch, however it should be understood that this system could be implemented using other hardware that does not resemble or even present a traditional user interface. When fully developed, it is expected that this invention will lead to a system that dynamically controls lights, fans, and other loads, without requiring any manual intervention or control. It is understood that in some embodiments, this system may also present an interface to the user through means such as but not limited to a smartphone app or verbal skill.

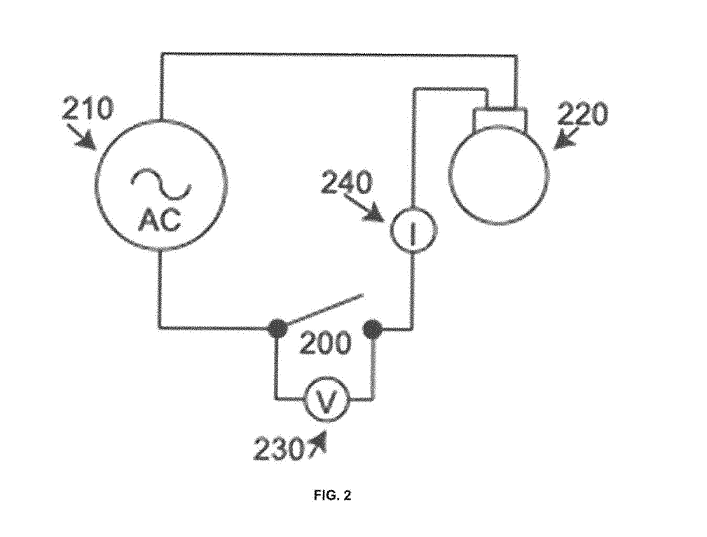

FIG. 2 shows a simplified circuit for an installed single pole switch 200. The circuit consists off power source 210 that may be alternating or direct current. It includes a load 220 that is typically a light, such as an LED bulb, a CFL bulb, an incandescent bulb, a low voltage DC bulb, an electroluminescent panel, a fan, or any other switchable load. The circuit may include a means of measuring line voltage at or across the switch 230, and/or current in line before or after the switch 240. Those skilled in the art will understand that this particular diagram is only one of many possible configurations and it is in no way restrictive.

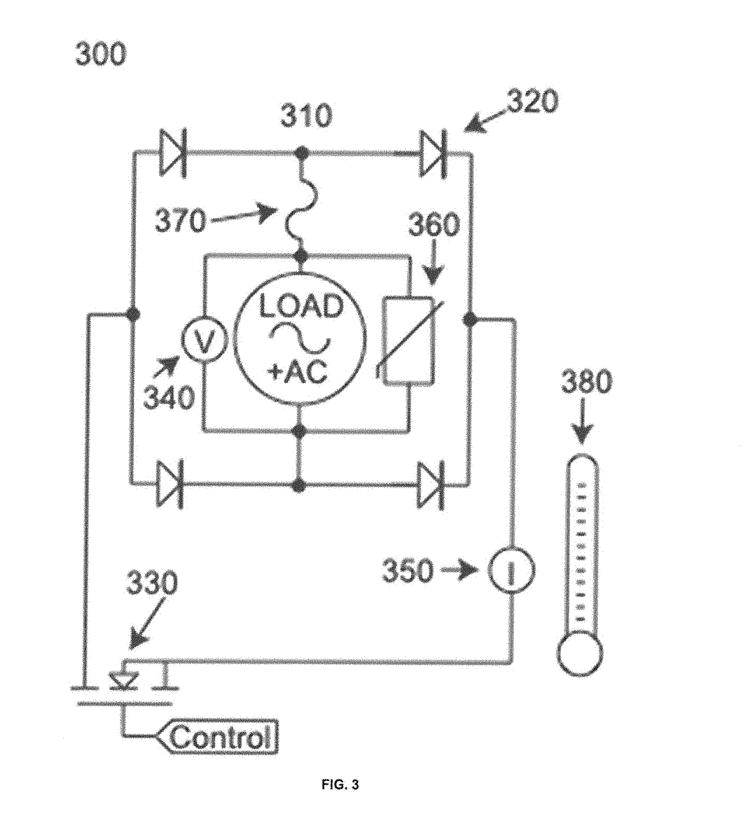

FIG. 3 shows one possible means of controlling electric transmission arranged in series between the power supply and load 300. In this embodiment, a rectifier 310 consisting of integrated or discrete diodes 320 and a switching element, in this case a power Metal Oxide Semiconductor Field Effect Transistor (MOSFET) 330. Some embodiments of this invention include a means of measuring relative voltages 340 or currents 350 measured in or across many parts of the circuit to determine zero crossing time or timing in an AC waveform. Some embodiments include a means of preventing over-voltage spikes from damaging or destroying the switching element, such as a varistor 360, or a bleeder resistor, or a Zener diode, or other means of passive or active over voltage protection across the load and/or between the load and the switching signal. Some embodiments include a means of limiting current inflow outflow for the switching element such as a reversible or irreversible fuse 370, a positive temperature coefficient resistor, or other means. Some embodiments include a means of measuring and reacting to temperature 380, or other means of determining the health and safety of the switching element.

Many other means exist that are known to those skilled in the art of electronics including, but not limited to, Insulated Gate Bipolar Transistors (IGBTs), other power transistors, solid state relays, back-to-back MOSFETs, thyristors, triacs, and many others.

Those skilled in the art will understand that this circuit can be trivially generalized to drive two or more loads or, equivalently, be used in a three-way or other wiring configuration.

Not shown here is a means of generating low voltage DC from mains voltage which is required for some embodiments. There are many approaches to this that are well established and known to those skilled in the art. It is worth noting here that in some of these configurations, it is not possible to provide 100% of the available voltage to the load. In such embodiments, some means, must be implemented to restrict the output to an allowable range. This can be achieved through additional electronics or through software control restrictions.

in embodiments that require low voltage DC to be generated from the same circuit as the load, it is essential that the current be tightly restricted as modern lights such as LEDs are highly efficient and can be visibly dim but on if the baseline current flow through hem too high. Other loads such as compact fluorescent lights can behave badly even if the current is tightly restricted and other means can be applied to limit current flow to a small duty cycle. Those skilled in the art will understand how to implement such a system using solid state switching elements such as a Junction gate Field Effect Transistor (WET), MOSFET, bipolar transistor, etc.

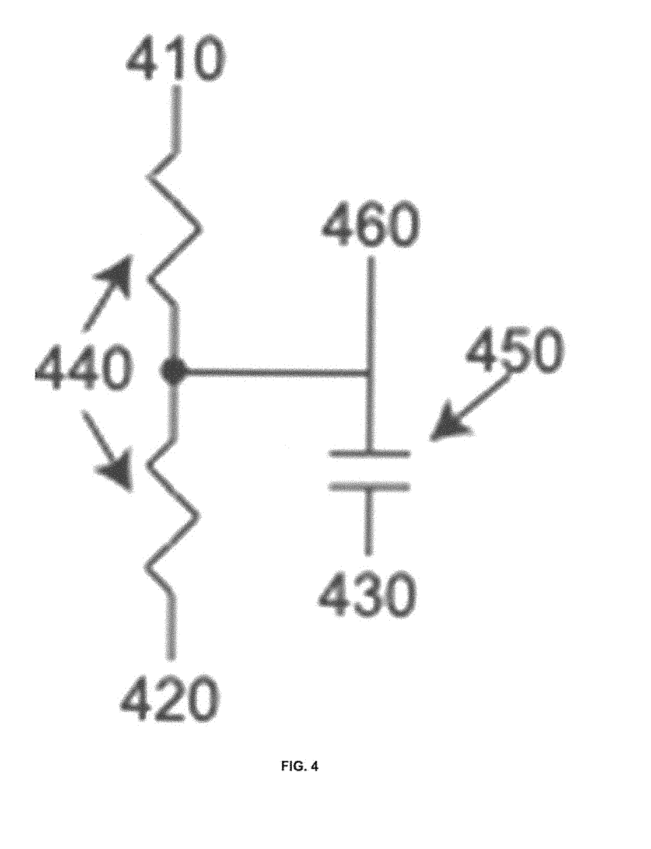

FIG. 4 shows a simplified circuit for using a resistive voltage divider 400 to infer voltage between 410 and 420. In some embodiments, this circuit includes two resistors 440. In some embodiments, this circuit includes a filter capacitor 450. In some embodiments, the divided voltage is measured by an analog to digital converter 460. This is one of many possible measuring techniques known to those skilled in the art of electrical engineering.

In some embodiments, a means for electrically isolating the measured voltages and the analog to digital converter such as an optoisolator may be used. In some embodiments, electronics can be used to directly measure zero crossings and power transfer without the need for an analog to digital converter.

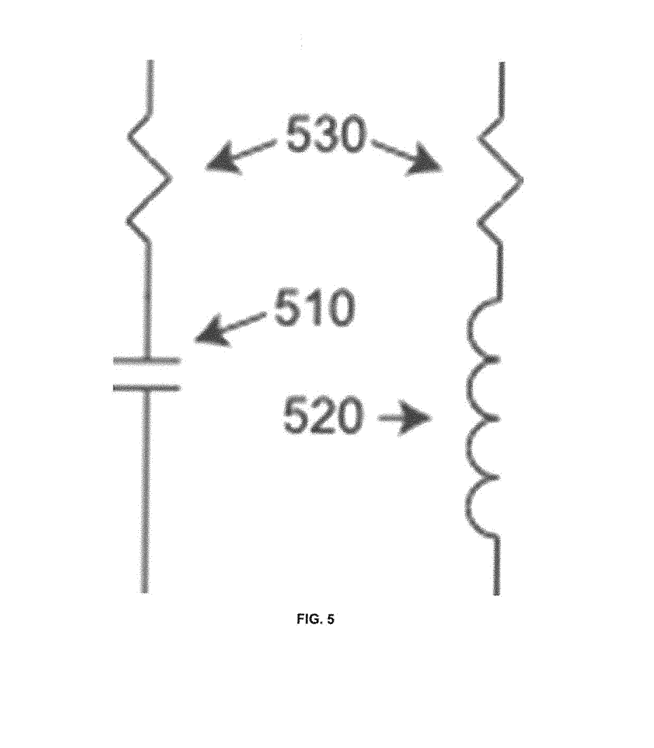

FIG. 5 shows simplified circuit diagrams for loads 500. It is important to understand the behavior of the load in order to control it and most common loads have behavior dominated either by an effective capacitance 510 or inductance 520 along with series resistance 530. It will be apparent to those skilled in the art that these are highly simplified and that typical loads have some combination of effective inductance, resistance, and capacitance. Although it is not shown in this disclosure, there ate obvious generalizations that can be applied in some embodiments.

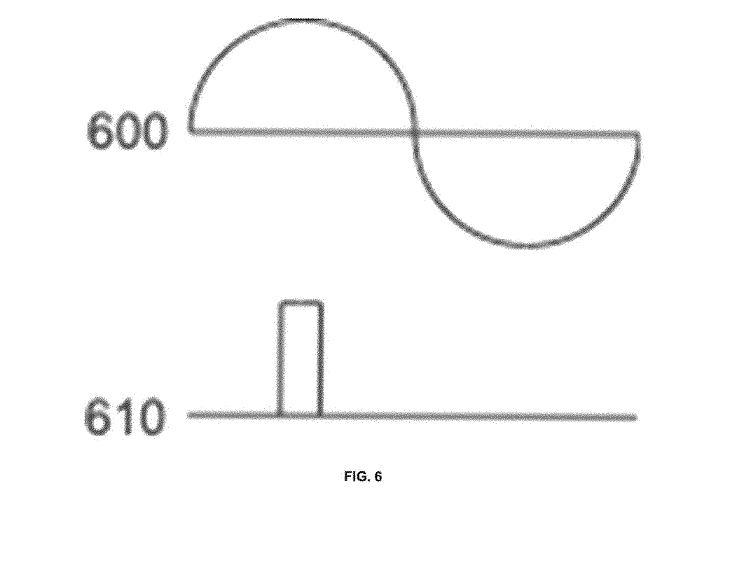

FIG. 6 shows AC voltage potential (600 vertical) across an open switch as a function of time for a single complete cycle. It also shows generation of a simple, nearly square impulse 610 aligned in this embodiment to maximize driving voltage. This is one of many possible ways to excite and characterize the load that are well known to those skilled in the art of control theory. By monitoring the voltage, current, any combination thereof, or some other measure of the load system's signal response, the load can be identified.

Those skilled in the art will understand that there are many other well-known means of characterizing the load and identifying load type that can be used in some embodiments.

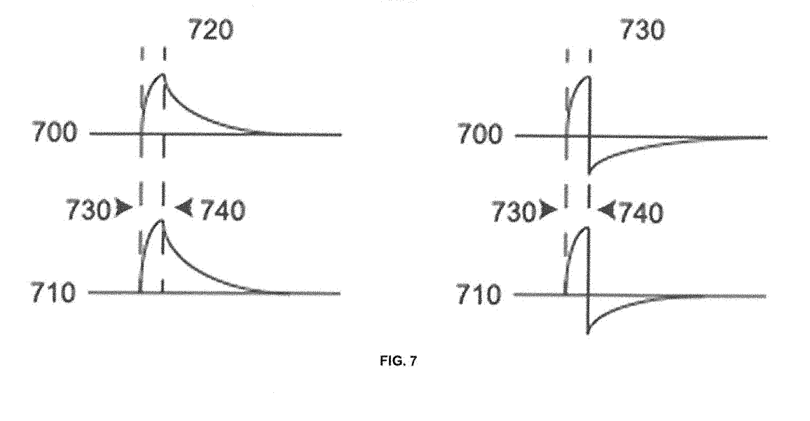

FIG. 7 shows simplified signal response voltage 700 and current 710 curves for capacitive 720 and inductive 730 dominated loads in response to the step function driver from FIG. 6 with timing for start shown as the vertical dashed lines on the left 740 and stop as the vertical dashed lines on the right 750. This is one of many standard approaches to system identification that are well known to practitioners skilled in the art of control theory. In some embodiments, the detailed response of the load is analyzed, used to categorize the load, and adjust the switching control schedule.

Those skilled in the art will understand that a great deal more information can be learned from actively exciting or passively monitoring loads, and that these are highly simplified and stylized responses. In particular, it is possible to characterize both the load and the wiring using an obvious generalization of this approach in some embodiments.

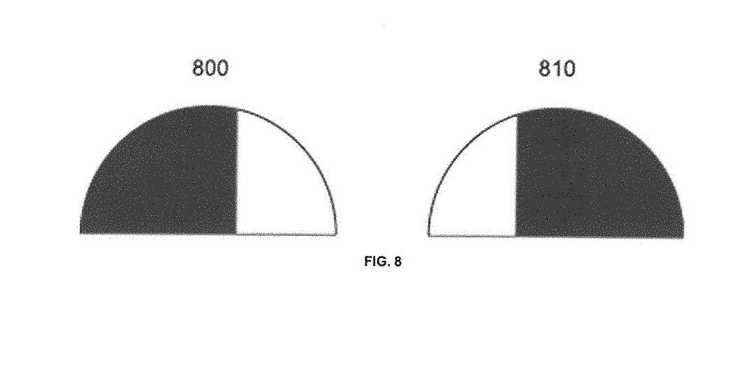

FIG. 8 shows leading 800 and trailing 810 edge switch timing which repeats every half-cycle [from zero to zero]. These switching/control schedules are chosen because typical solid-state switches are inefficient when they are not completely on or off so it is important to minimize time between the on/off states. Leading edge [on from the zero and cutting off at some time afterwards depending on desired intensity] tends to be most appropriate for capacitive loads. Trailing edge [off until sometime then off at the zero] tends to be most appropriate for inductive loads. Appropriately selecting between these two modes for a given load significantly improves performance and longevity, and decreases system noise. The filled sections represent the «on» and the empty «off». Intensity is controllable by increasing or decreasing the extent of the filled (on) state.

Those skilled in the art will understand that there are many other potential switching schedules. Leading and trailing edge schedules are often chosen because they minimize switching losses and are natural fits for many common solid-state switching electronics. In some embodiments, switching times will not resemble leading or trailing edges and may include but are not limited to both starting and stopping current flow midway through a cycle, pulse width, pulse frequency, and pulse phase modulation. In some embodiments, switching will not be binary and can dynamically shape pulses or apply some arbitrary effective resistance. Such approaches are desirable because they avoid things like inductive spiking triggered by hard switching. In some embodiments filter electronics can be used to remove hard edges and replicate the sine wave of line current or other waveforms with desirable properties.

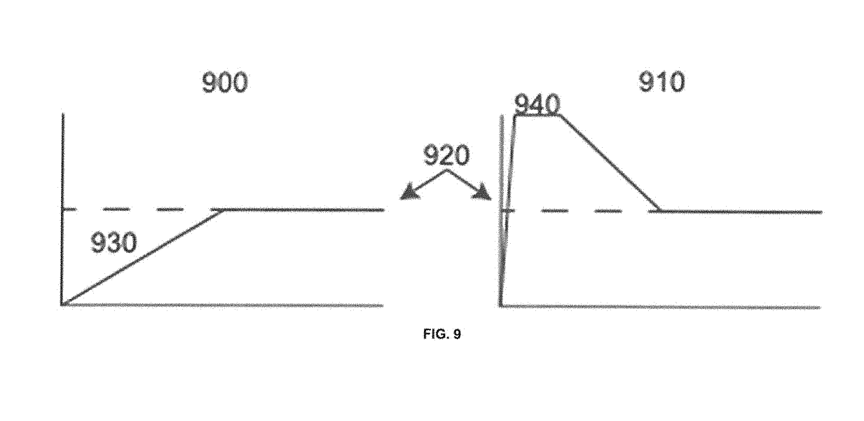

FIG. 9 shows possible startup sequences for two common types of loads. 900 shows timing duty cycle increasing gradually 930 from off to a set point value 920 to soft-start dimmable loads like an LED to avoid the perception of a sudden flash from dark to bright, and to minimize the impact on the LED driver electronics. 910 shows timing duty cycle quickly ramping to 100% 940 then decreasing to a set point value 920 to spin up a fan or similar load.

Those skilled in the art will understand that these are only one set of schedules and there are many alternatives that can be used to achieve specific goals or work best for specific loads.

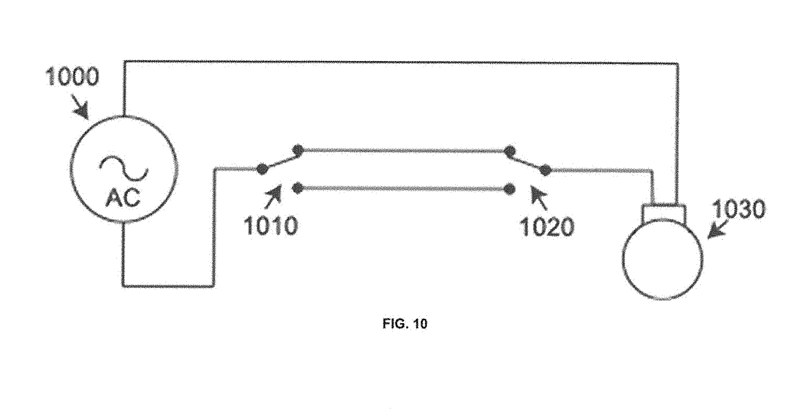

FIG. 10 shows a simplified wiring diagram for a three-way switch. In some embodiments, the mains are AC 1000. Three-way wiring allows two switches, 1010 and 1020, to control a single load 1030. One or both of 1010 and 1020 can be mechanical or a switch as laid out in this invention. Electrical sensing on the wires connected to each switch can determine the topology and state of such an arrangement to allow an embodiment of the switch presented here to replace a conventional 3-way switch. This arrangement can easily be generalized for N-way switches in sonic embodiments of this invention. In some embodiments of this invention, two or more switches exchange information to simulate N-way switching without the need for this type of wiring or even a physical connection between the switch(es) and the load. Many other arrangements are possible and will be obvious to those skilled in the art.

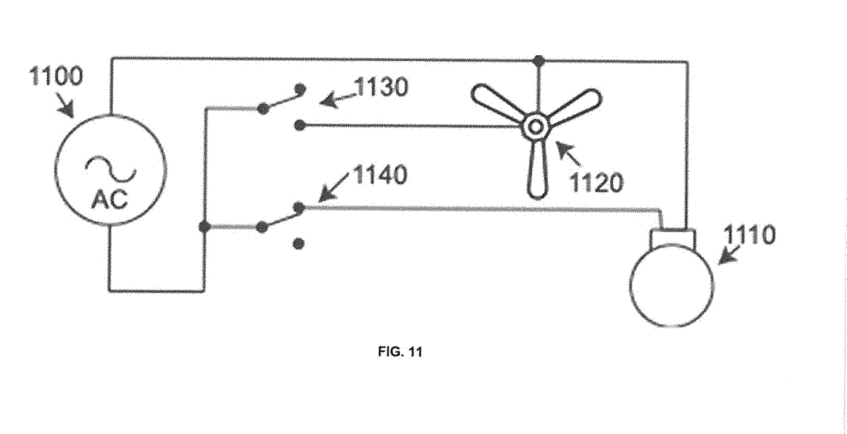

FIG. 11 shows a wiring diagram for an embodiment of this invention using mains voltage 1100 to drive two loads—in this case a light 1110 and a fan 1120. In such an embodiment, a single switch is able to control any combination of up to two lights and fans using a generalization of the circuit in FIG. 3 which allows it to behave effectively as two independent switches, 1130 and 1140. In some embodiments, load detection is used to automatically identify and categorize whether the switch is in the single-pole (FIG. 2), three-way (FIG. 10), or two-load (FIG. 11) configuration. Some embodiments of this invention support three or more loads or traveler wires.

Those skilled in the art will understand that there are many obvious generalizations that may be used in some embodiments. In viewing FIGS. 10 and 11 together, many other possibilities should become obvious to those skilled in the art.

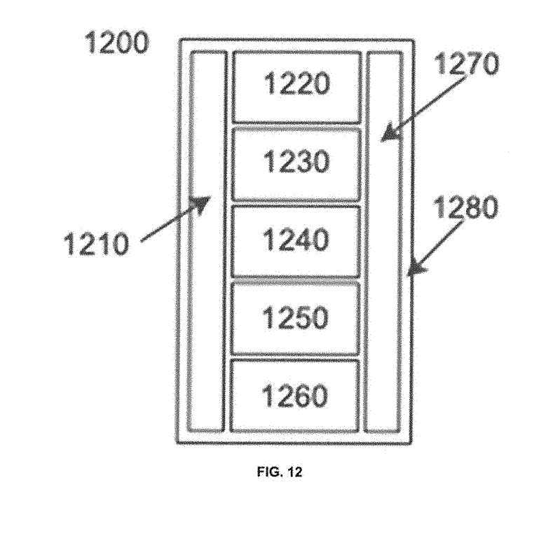

FIG. 12 shows a possible touch sensor arrangement. In some embodiments, the individual pads 1200 of such an arrangement would be capacitive touch and proximity sensors. In some embodiments, a signal guard channel 1280 could be used to reduce interference and improve performance. In some embodiments, a vertical series of pads 1220, 1230, 1240, 1250, 1260, could be used to determine vertical position of a contact event on the sensor. In some embodiments, pads at horizontal extremes 1210, 1270, could be used to identify contact events moving left-to-right or right-to-left. Such a geometry allows for a rich gesture vocabulary including taps, long-presses, vertical and horizontal swipes, and other movements and chords. Some example gestures include tapping to turn the lights on/off, sliding up and down to brighten and dim, swiping left/right to turn a fan on/off and adjust its speed, a long-press to identify a Switch to an app.

Those skilled in the art will understand that there are many other possible arrangements for touch sensors, and many other technologies including but not limited to inductive, acoustic, resistive, and optical touch sensing. They will also be aware that it'is trivial to add mechanical switches, bump or motion detection, etc. to some embodiments.

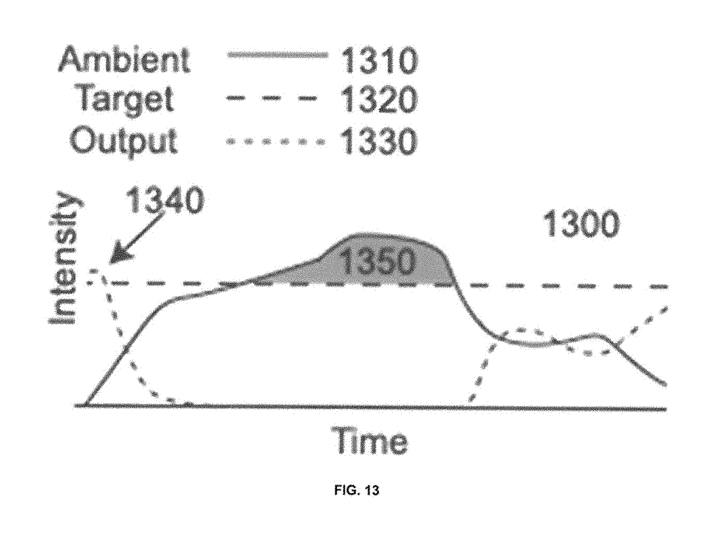

FIG. 13 shows the use of a sensor such as a camera or ambient light sensor 1300 to identify ambient intensity 1310 to maintain constant perceived brightness matching a target set point 1320 as closely as possible by dynamically adjusting light output 1330. Typically, artificial lighting is not sufficient to match sunlight's brightness. If the target intensity is set above the ability of the, lights to compensate, output can be automatically set to 100% to approximate the set point as closely as possible 1340. At times when the ambient intensity exceeds the set point, it is impossible to remove light without adding shading, so in cases where that is not an option, light output is set to zero 1350. In general, light output is not a linear function of power input. In some embodiments of this invention, those nonlinearities are taken into account and compensated for. In general light distribution of artificial light will not match light distribution from natural sources. In some embodiments of this invention, the relative contributions of two or more light sources or shades are taken into account and the mix of brightening and/or darkening, effects is dynamically adjusted to bring light levels at one or more points as close to the desired level as possible.

Those skilled in the art will understand that perceived light level and comfort are highly subjective and there are other obvious choices for control which may be used in some embodiments.

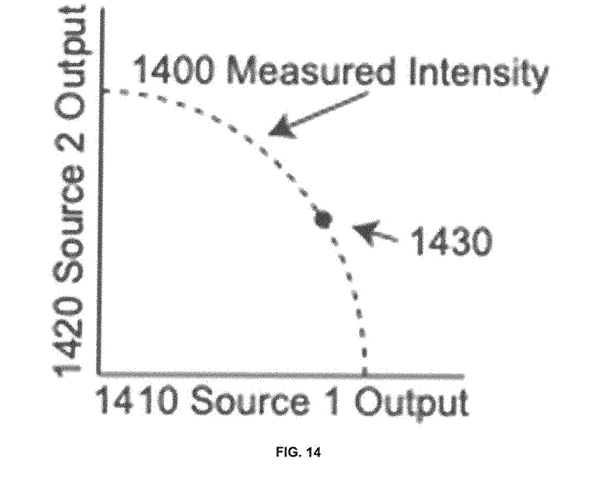

FIG. 14 shows dynamically adjusting the values of multiple light sources and/or shades to achieve a desired intensity 1400. In this example, there are two sources, 1410 and 1420, but in some embodiments, there may be many which may be controlled by one or more linked switches and one or more linked sensor. There are many ways to configure the mixing of multiple light sources and shades to select a particular combination of output intensities to achieve a desired intensity 1430. In some embodiments, users manually adjust the mix. In some embodiments, the relative influence of each source or shade is identified in advance through some means of system identification and some means of control is used to adjust all collectively. In some embodiments, an expert skilled in the art of classical control theory might identify a transfer function, and apply a control strategy possibly subject to one or more constraints, such as minimizing energy use. In some embodiments, small, possibly imperceptible adjustments can be made to determine the relative influence of various sources and to pick a course of action based on the current state, desired state, and ambient intensity.

It will be obvious to those skilled in the art that this is highly simplified for illustrative purposes and for N-controls this generalizes to an N-1 hyper surface which may have a more complicated geometry or topology. In some embodiments, the mixing may be treated as approximately linear, in which case this figure would simplify to a single diagonal line, and the hyper surfaces for larger numbers of light sources and shades reduce to gun (N-1)-simplex. On that realization, it should be obvious that there are many well-known optimization strategies available for use in some embodiment of this invention.

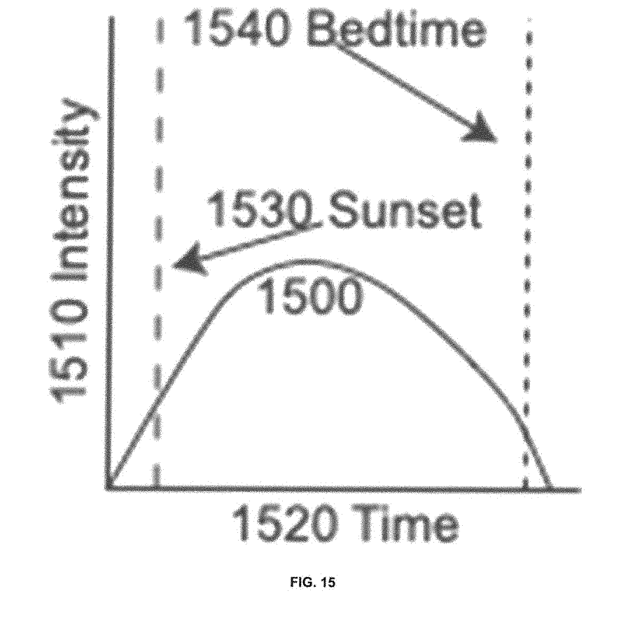

FIG. 15 shows dimming lights 1500 to simulate a later sunset. Here intensity 1510 is on the vertical axis vs time 1520 on the horizontal. The actual sunset 1530 may be much earlier than the desired bedtime 1540. By knowing the desired bedtime, and human day-night, sleep-wake cycle, light levels can be dynamically adjusted to encourage sleep or prepare for waking up in the morning. In some embodiments, the user sets their desired sleep and wake times. In some embodiments, sleep and wake times are discovered or inferred automatically.

Some embodiments can use this or a similar approach for time shifting and stretching day-night cycles to influence circadian rhythms.

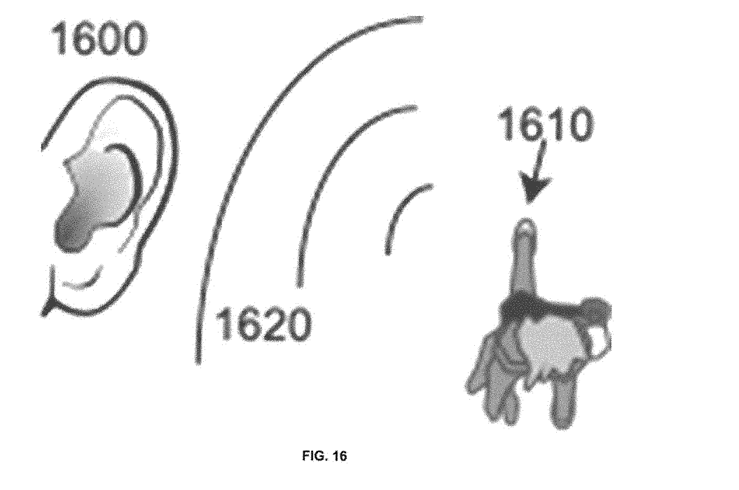

FIG. 16 shows inferring presence and activity by analyzing ambient sounds with a sensor 1600 and means of processing. This approach is effectively a form of passive sonar where sounds that may even be imperceptible to people such as those generated by walking 1610 are transmitted through the air 1620 detected by a sensor 1600 and processed. In some embodiments, there is a database of signatures to identify various background noise sources in much the same way as a song eau be identified. In some embodiments, machine learning techniques are applied to establish such a database. In some embodiments, machine learning techniques are applied, to determine the appropriate response to specific activity signatures whether their source can be positively identified or not. In some embodiments, sound signatures are identified through fast convolutions such as fast Fourier transform or fast wavelet transform.

Many approaches to this sort of ambient sound analysis will be apparent to those skilled in the art and may be used in some embodiment of this invention.

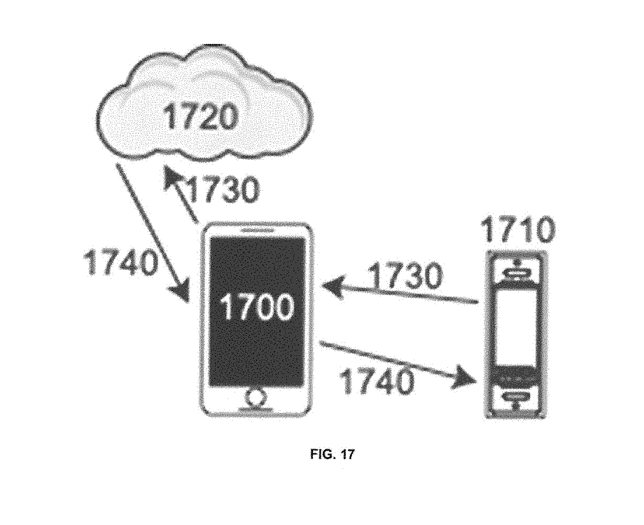

FIG. 17 shows the use of a smartphone 1700 to connect a device specified by this invention 1710 to networked services possibly cloud hosted 1720. This invention does not require a smart phone or other external system to operate and be useful, but in some embodiments, it is enhanced by them. In particular, device logs can be uploaded 1730 to aid in debugging, enhance performance, or for use in cloud based, smartphone based, or otherwise external machine learning. Profiles and firmware updates can then be pushed back to a device specified by this invention 1740.

An ideal embodiment of this invention would not require any manual configuration or setup from the end user once it is installed, but some embodiments may.

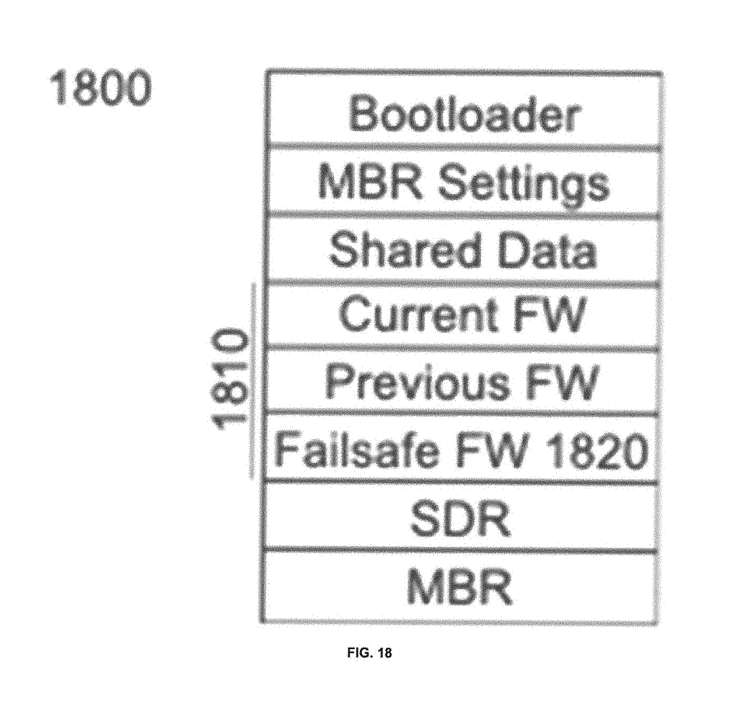

FIG. 18 shows a possible memory map 1800 to support multiple firmware images 1810, including an emergency «fail-safe» image 1820. The particular arrangement of these images may differ in some embodiments. In some embodiments, one or more areas of memory may reside in an external memory bank. The Master Boot Record (MBR) starts the boot loader. The boot loader is aware of the current memory map and upload status and may trigger an over the air update, a normal firmware launch, or a fallback to an older firmware build, including the failsafe image. In some embodiments, the failsafe firmware image may be written in non-erasable memory. In some embodiments, cryptographic hashes or encrypted sections of memory or firmware images may be used to enhance security and to ensure that the device and firmware have not been tampered with. The specific implementation details of the memory arrangement and image sizes depend on many factors including the micro controller architecture and resources and so are not specified here and may be determined by an expert skilled in the art of firmware architecture and implementation.

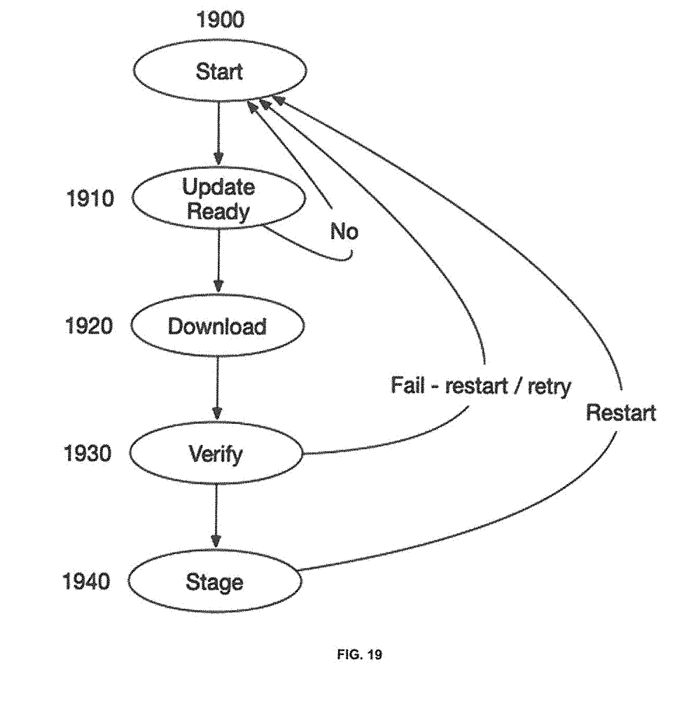

FIG. 19 shows a procedure for updating the device firmware, over the air possibly via smartphone 1900. In some embodiments of this invention, this arrangement can be used to deploy bug fixes and to enhance the invention's capabilities, user interface, performance, etc. A key feature of this approach is that it is designed to be highly robust and to allow failures to be recoverable—ideally without the end user being aware that they have happened. When a new firmware image becomes available, the invention becomes aware of it through sonic means. In some embodiments, the invention actively polls the cloud store for new compatible images. In some embodiments, a push notification is routed to the device through some means 1910. The new image is transferred 1920 to a safe portion or memory where it will not interfere with existing images, particularly the failsafe and boot loader, ideally there is enough memory to support a scratch space where the new image can be temporarily stored. The image is then processed and, in some embodiments, verified 1930.

Verification may include looking at a checksum, hash function, cryptographic signature, etc. If the image was encrypted, it may be decrypted or used encrypted. In some embodiments, the image is then transferred to a staging area of memory 1940 where it can be executed. When ready and in some embodiments, when it will not cause a disruption of service, the new image is executed possibly following a quick reboot, or possibly not. In some embodiments, a system is used that can identify failures of the firmware. This and other approaches to improve robustness that may be used in some embodiments are used in things like embedded systems, satellite, and robotic systems for space missions and will be obvious to those skilled in the art.

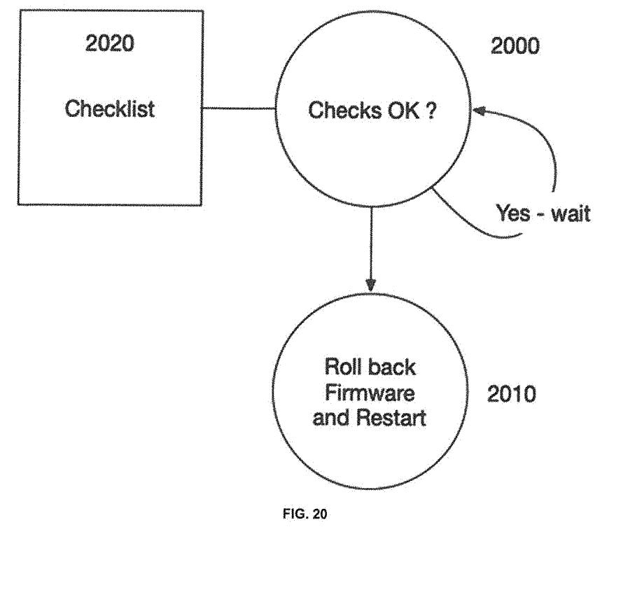

FIG. 20 shows a simplified diagram of one system for failure detection and recovery—a watchdog timer 2000. A watchdog periodically checks to determine if one or more criteria have been satisfied. The simplest form is a go/no-go bit where if the bit is not set, the system reboots and either retries with the same firmware once or more, or falls back to an earlier build 2010 or to the failsafe known good firmware image. In some embodiments, this bit is replaced with a checklist 2020 that can allow for more complicated behavior.

Although in this figure the behavior is simply reboot and rollback on failure, it will be obvious to someone skilled in the art that this can be much more complicated in some embodiments and can include a larger checklist and two or more responses to various types of failures and successful or unsuccessful recoveries.

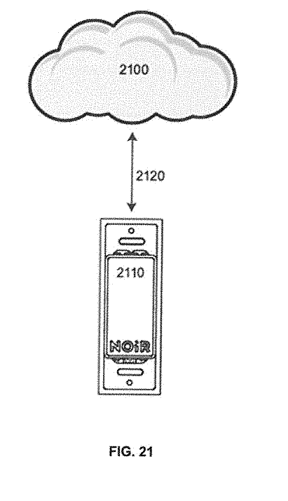

FIG. 21 shows machine learning in the cloud 2100 and onboard 2110, either or both of which may be used in some embodiments. In some embodiments, learning in the cloud is facilitated by uploading sensor and device logs to the cloud 2120 where machine learning algorithms such as hidden Markov models and deep learning may be applied to build and refine profiles, weights, and configurations that can be downloaded to one or many embodiments. The downloaded data defines and improves models capable of identifying the current state of the environment and responding accordingly. In some embodiments, these models are built or refined onboard, some embodiments, these transfers are facilitated by a base station, a hub, a smart z hone, or other networked device.

Note that through wired or wireless networking, it is possible to generalize this invention to separate the actual switching electronics from a control interface. In some embodiments, the user facing Switches, themselves, may be remote controls for the actual control/switching electronics.

What is claimed is:

1. A semi-autonomous switching system comprising:
at least one sensor to monitor current needs to a load coupled to the semi-autonomous switching system; and
a circuit coupled to the at last one sensor interpreting data from the at least one sensor and to adjust the current based on needs.

2. The system of claim 1, comprising a user interface coupled to the circuit to manually control the circuit.
